(19) United States
(12) Patent Application Publication
(10) Pub. No.: US 2026/0127664 A1
(43) Pub. Date: May 7, 2026

(54) Auction-Based Multi-Round Bidding Game with Champion Progression and Strategic Budget Management Dynamics

(71) Applicant: Mustafa Kulekci, Bloomington, IN (US)

(72) Inventor: Mustafa Kulekci, Bloomington, IN (US)

(21) Appl. No.: 19/382,109

(22) Filed: Nov. 6, 2025

Related U.S. Application Data
(60) Provisional application No. 63/717,175, filed on Nov. 6, 2024.

(51) Int. Cl. G06Q 30/08

(52) U.S. Cl. CPC G06Q 30/08

(57) ABSTRACT

A computer system provides a multi-round auction with a preferred embodiment permitting a winner bidders of a round of bidding to automatically skip to a round of bidding, reducing budgets as bidding occurs, and displaying some of the bids to some of the remaining bidders.

### RELATED APPLICATION

The present application claims the benefit of U.S. Provisional Patent Application Serial No. titled “AUCTION-BASED MULTI-ROUND BIDDING GAME WITH CHAMPION PROGRESSION AND STRATEGIC BUDGET MANAGEMENT DYNAMICS” to Mustafa Kulekci, filed on Nov. 6, 2024, the entire disclosure of which is expressly incorporated by reference herein.

### FIELD OF THE DISCLOSURE

The present application relates to systems and methods of auctioning items.

### BACKGROUND AND SUMMARY OF THE DISCLOSURE

Methods of auctioning are a known way to sell and purchase goods and services, with auctioned goods and services being awarded to the top bidder.

According to the present disclosure, a method of auctioning at least one item is provided. The method includes the steps of determining a budget for each of a plurality of first bidders and providing a first round of bidding for at least one item that receives first bids from the plurality of first bidders. The first bids are less than the budget of each of the plurality of first bidders. The method further includes the steps of determining a top bidder from the plurality of first bidders based on the first bids, automatically advancing the top bidder to a third round of bidding, determining a second round of second bidders that includes a portion of the plurality of first bidders that provided higher first bids in the first round of bidding, reducing the budget of each of the plurality of second bidders and the top bidder by their first bids made in the first round of bidding, and providing a second round of bidding that receives second bids from the plurality of second bidders. The second bids are less than the budget of each of the plurality of second bidders. The method further includes the steps of determining a third round of third bidders that includes a portion of the plurality of second bidders that provided higher second bids in second round of bidding and the top bidder, reducing the budget of each of the plurality of third bidders by their second bids made in the second round of bidding, concluding the bidding when two bidders remain, and determining a winner as the bidder with the highest remaining budget.

According to another aspect of the disclosure, a computer system for determining the purchaser of at least one item is provided. The computer system includes memory, a processor, and means for determining an overall winner of a multi-round auction from a plurality of bidders, with an intermediate winner of a round automatically skipping a round while the remaining bidders from the plurality of bidders bid against each other in a subsequent round.

According to another aspect of the present disclosure, a computer system for determining the purchaser of at least one item is provided. The computer system includes memory, a processor, and means for disclosing bids from a round of bids from a plurality of bidders. The plurality of bidders includes a top bidder having a highest bid from the round of bids and a plurality of lower bidders. The bids of the lower bidders are disclosed to the lower bidders and the top bidder while the highest bid is retained from the lower bidders.

### BRIEF DESCRIPTION OF THE DRAWINGS

FIG. 1 shows a computer system programed to determine the winner of an item after a multi-round auction.

FIG. 2 shows a table illustrating the inputs and outputs of several rounds of bidding how each auction begins, where the number of rounds has already been calculated and the budget is predetermined.

### DETAILED DESCRIPTION OF THE DRAWINGS

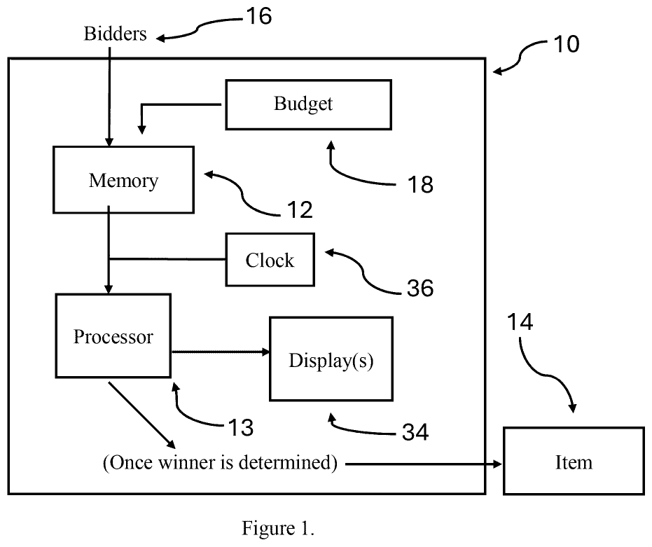

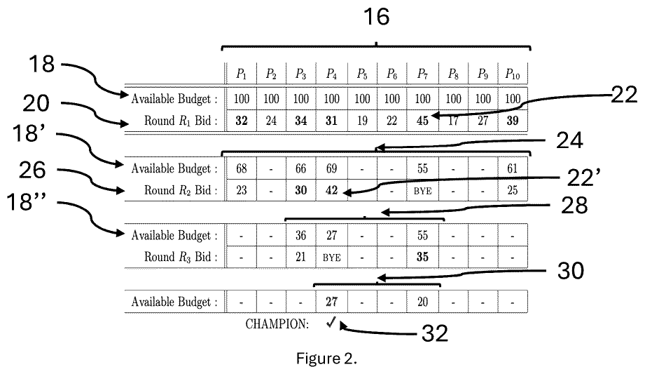

As shown in FIG. 1, a computer system 10 is provided that has memory 12 including programming operated by a processor 13 that determines the winner of a multi-round auction with the winner receiving an item 14. As shown in FIG. 2, the auction starts with a plurality of first bidders 16 (P1 . . . P10). Each first bidder 16 establishes an available budget 18 for the auction and computer system 10 determines the budget for each of the plurality of first bidders 16 based on established budget 18. Computer system 10 may be programmed to limit available budgets 18 to a predetermined range or a specific amount so that each first bidder 16 starts with the same available budget 18. For example, in FIG. 10, each of the plurality of first bidders 16 established an available budget 18 of 100 units, such as U.S. dollars, although budgets 18 for each first bidder 16 may be different.

Computer system 10 then provides a first round of bidding for item 14 and receives first bids 20 from plurality of first bidders 16. First bids 20 must be less than budgets 18 (ex. $100) of each of plurality of first bidders 16. Although only ten bidders are illustrated in FIG. 2, fewer or more bidders 16 may participate in the first round of bidding. Preferably, the auction starts with at least five first bidders 16.

Next, computer system 10 determines a top bidder 22 from plurality of first bidders 16 based on the first bids. In the example in FIG. 2, top bidder 22 (P7) placed the highest bid of $45. Computer system 10 automatically advances top bidder 22 (P7) to a third round of bidding, discussed below. In other words, top bidder 22 (P7) skips the second round of bidding.

Computer system 10 then determines which of first bidders 16 should advance to a second round of bidding. Computer system 10 determines the second round of second bidders 24 that includes a portion of a plurality of first bidders 16 that provided higher first bids in the first round of bidding. For example, second bidders 24 may include first bidders 16 that placed in the top half of bids in the first round. As shown in FIG. 2, the top half of first bidders 16 includes P1, P3, P4, and P10. With the exception of top bidder 22, the other first bidders 16 are eliminated from the auction.

After determining second bidders 24, computer system 10 reduces budget 18 of each of second bidders 24 and top bidder 22 by first bids 20 made in the first round of bidding, creating budgets 18′. For example, budget 18 of P1 was reduced from $100 to $68 after subtracting P1's bid 20 of $32 as shown for P1 and the other remaining bidders.

Next computer system 10 provides a second round of bidding that receives second bids 26 from the plurality of second bidders 24. Second bids 26 must be less than budget 18′ of each of the plurality of second bidders 24.

Next, computer system 10 determines a top bidder 22′ from plurality of second bidders 24 based on the second bids. In the example in FIG. 2, top bidder 22′ (P4) placed the highest bid of $42. Computer system 10 automatically advances top bidder 22′ (P4) to a fourth round of bidding, discussed below. In other words, top bidder 22′ (P4) skips the third round of bidding.

Computer 10 then determines a third round of third bidders 28 that includes a portion of plurality of second bidders 24 that provided higher second bids 26 in the second round of bidding and top bidder 22, who skipped the second round of bidding. For example, third bidders 24 may include second bidders 24 that placed in the top half of bids in the second round. As shown in FIG. 2, the top half of second bidders 24 includes P3 and P4. Along with top bidder 22 from the first round that skipped the second round of bidding, these second bidders are third bidders 28.

After determining third bidders 28, computer system 10 reduces budget 18′ of each of third bidders 28 and top bidder 22′ by second bids 26 made in the second round of bidding, creating budgets 18″. For example, budget 18′ of P3 was reduced from $66 to $36 after subtracting P3's second bid 26 of $30 as shown for P3 and the other remaining bidders.

Computer 10 continues additional rounds of bidding, automatically advancing top bidders, reducing budgets, etc. until concluding the bidding when two bidders remain 30. Because there are only two bidders remaining, the top bidder of the second to last round does not skip the last round of bidding. Preferably, there are at least three rounds of bids.

Next computer 10 determines a winner/champion as the bidder with the highest remaining budget, such as winning bidder 32 as shown in FIG. 2. In the event of a tie, computer 10 randomly selects a winning bidder between the tie bidders. Item 14 is then delivered to winning bidder 32.

On occasion, bidders that have the lowest bids in the top half of bidders may have equal bids during a round. Or top bidders may have the same top bid. To break such a tie, computer system 10 determines which of the tie bids was placed first in time and advances this bidder to the next round or in the case of tied top bidder, award top bidder status to the first in time top bidder and advancing the second in time top bidder to the next round. The other lowest bidder in the top half does not advance.

During each round of bidding, computer 10 may disclose the previous bids of the remaining bidders to the other remaining bidders, including the top bidder, on a display 34. Each bidder may have their own display 34, such as a computer screen, smart phone, monitor, etc.

However, according to the preferred embodiment of the present disclosure, the top bidder's bid is not disclosed to the remaining bidders.

A time limit is placed on each round of bidding. Computer 10 includes a clock 36 to count down the remaining time, which is also displayed to the bidders. When the time expires or when a bid is entered, computer 10 checks the validity of the bid against each bidder's available budget for each round, rejecting invalid bids and allowing bidders to enter a valid bid. Additional details of the present disclosure are provided in U.S. Provisional Patent Application Serial No. titled “AUCTION-BASED MULTI-ROUND BIDDING GAME WITH CHAMPION PROGRESSION AND STRATEGIC BUDGET MANAGEMENT DYNAMICS” to Mustafa Kulekci, filed on Nov. 6, 2024, the entire disclosure of which is expressly incorporated by reference herein.

1. A method of auctioning at least one item,
determining a budget for each of a plurality of first bidders,
providing a first round of bidding for at least one item that receives first bids from the plurality of first bidders, the first bids being less than the budget of each of the plurality of first bidders,
determining a top bidder from the plurality of first bidders based on the first bids,
automatically advancing the top bidder to a third round of bidding,
determining a second round of second bidders that includes a portion of the plurality of first bidders that provided higher first bids in the first round of bidding,
reducing the budget of each of the plurality of second bidders and the top bidder by their first bids made in the first round of bidding,
providing a second round of bidding that receives second bids from the plurality of second bidders, the second bids being less than the budget of each of the plurality of second bidders,
determining a third round of third bidders that includes a portion of the plurality of second bidders that provided higher second bids in second round of bidding and the top bidder,
reducing the budget of each of the plurality of third bidders by their second bids made in the second round of bidding,
concluding the bidding when two bidders remain, and
determining a winner as the bidder with the highest remaining budget.

2. The method of claim 1, wherein at least one of the first and second higher bids is in about the top half of the first and second bids, respectively.

3. The method of claim 1, where the budget is determined by providing a predetermined range to the plurality of first bidders.

4. The method from claim 1, further comprises a step of breaking ties between identical bids from at least one of the first, second, and third bids based on which of the identical bids was placed first in time.

5. The method of claim 1, further comprising a step of disclosing the first bids to second bidders and top bidder while retaining the top bid from the second bidders.

6. A computer system for determining the purchaser of at least one item comprising
memory,
a processor, and
means for determining an overall winner of a multi-round auction from a plurality of bidders, with an intermediate winner of a round automatically skipping a round while the remaining bidders from the plurality of bidders bid against each other in a subsequent round.

7. The computer system of claim 6, wherein each round of the multi-round auction has at least one top bidder and the at least one top bidder in the last two rounds of the multi-round auction does not automatically skip a round.

8. The computer system of claim 6, wherein the plurality of bidders includes at least five bidders.

9. The computer system of claim 8, wherein the multi-round auction has at least three rounds of bidding.

10. The computer system of claim 6, wherein the multi-round auction has at least three rounds of bidding.

11. A computer system for determining the purchaser of at least one item comprising
memory,
a processor, and
means for disclosing bids from a round of bids from a plurality of bidders, the plurality of bidders including a top bidder having a highest bid from the round of bids and a plurality of lower bidders and the bids of the lower bidders being disclosed to the lower bidders and the top bidder while the highest bid being retained from the lower bidders.

12. The computer system of claim 11, wherein each of the plurality of bidders has a budget which is reduced by a respective bid after the plurality of bidders place a bid resulting in a plurality of reduced budgets.

13. The computer system of claim 12, wherein the reduced budgets are retained from the plurality of bidders in a subsequent round.
